(19) United States
(12) Patent Application Publication
(10) Pub. No.: US 2009/0242071 A1
(43) Pub. Date: Oct. 1, 2009

(54) VALVE ACTUATOR FOR ELEVATED WATER TANKS

(75) Inventor: Lonnie R. Hamberg, Phoenix, AZ (US)

Correspondence Address: The VON HELLENS LAW FIRM, LTD., 7330 N 16TH STREET, SUITE C 201, PHOENIX, AZ, 85020, US

(73) Assignee: PORTABLE POND L.L.C., Phoenix, AZ (US)

(21) Appl. No.: 12/057,952

(22) Filed: Mar. 28, 2008

(51) Int. Cl. B67D 5/02; B67D 5/12; B67D 5/34

(52) U.S. Cl. 141/1; 141/250

(57) ABSTRACT

An outlet conduit extends from an elevated water storage tank for discharging water into the tank of a tanker truck, which truck transports the water to a location of use, such as spraying the water at a construction site for dust control. A manually or remotely controlled valve actuator in a conduit extending from the storage tank controls the flow of water to the tanker truck. Power for operating the valve actuator is provided by batteries and solar panels to recharge the batteries. A remote control, actuated by a driver of the tanker truck, transmits radio frequency signals to the valve actuator to control opening and closing of the valve. A manual override accessible with a chain extending downwardly from the valve actuator may be used in the alternative to the remote control.

### BACKGROUND OF THE INVENTION

1. Field of the Invention

The present invention relates to elevated water tanks and, more particularly, to a valve actuator for controlling the flow of water from the elevated tank to a tanker truck.

2. Description of Related Prior Art

The ground at most construction sites is dirt. During normal operations at such a construction site, significant dust is created by movement of vehicles, personnel and the wind. Numerous regulations require that controls be exercised to prevent more than a minor amount of dust. The general solution to such dust control involves the use of tanker trucks having a spray bar for discharging a spray of water onto the ground. The resulting wetted ground eliminates or at least reduces the likelihood of dust as a result of normal operations at the construction site.

The tanker trucks used require periodic refilling of water. If the construction site is at or in proximity to a developed area, water can be obtained through fire hydrants close by. The filling of the tank truck with a hose extending from the fire hydrant requires the driver, or his assistant, to insert the hose into the tank of the tanker truck and wait while the tank fills. This is generally time consuming and is a function of the flow rate from the fire hydrant.

Where fire hydrants are not available, a source of water must be provided. At some locations, an artificial pond is created to hold water. To fill the pond, tanker trucks must convey the water from a source of water and discharge it into the pond. This procedure is expensive and time consuming. An alternative is that of using a tank elevated upon stilts or the like and having a discharge hose extending downwardly therefrom. Generally, this hose must be inserted into the tank of the tanker truck and the associated water valve must be manually opened and closed by the driver or his assistant. Again, this is a time consuming operation and often results in loss of water due to mishandling and other issues.

### SUMMARY OF THE INVENTION

A conventional elevated water tank is mounted upon stilts or other supporting structure to maintain it elevated to an extent sufficient to maintain the bottom of the tank above the inlet to the tank of a tanker truck. A water discharge conduit extends from the elevated tank and includes a down spout for communicating with the inlet of the tank of the tanker truck. A valve actuator is disposed in the conduit to control flow of water therethrough. The actuator includes a valve that may be remotely controlled by the driver of the truck to permit the driver to control the flow of water into the tank. The valve actuator includes a battery operated electric motor for controlling operation of the valve. Solar cells provide electrical energy to maintain the batteries charged and thereby eliminate the need for a source of electrical energy at a construction site. A chain extending downwardly from the valve actuator permits manual override of the operation of the valve.

In operation, the driver parks the tanker truck relative to the down spout to align the down spout with the inlet to the tank of the tanker truck. By using a remote control, the driver controls the flow of water through the downspout into the tank. On fill of the tank, the remote control is used to close the valve and cease the flow of water. Thereafter, the tanker truck can be driven to the location of use of the water. Thereby, the driver need not leave the cab of his truck nor require other personnel to effect fill of the tank of the tanker truck, which minimizes the turnaround time for filling the tank of the tanker truck.

It is therefore a primary object of the present invention to provide a valve actuator for controlling the flow of water into a tanker truck.

Another object of the present invention is to provide a remotely controlled valve actuator for filling a tanker truck with water.

Still another object of the present invention is to provide a valve actuator for controlling the flow of water from an elevated tank into a tank mounted on a tanker truck.

Yet another object of the present invention is to provide a battery energized valve actuator for controlling the flow of water to a tanker truck.

A further object of the present invention is to provide batteries and attendant solar panels for charging batteries to operate a valve actuator that controls the discharge of water from an elevated tank.

A still further object of the represent invention is to provide a valve actuator that may be remotely or manually operated to control the flow of water therethrough.

A further object of the present invention is to provide apparatus for filling the tank of a tanker truck with water that does not require the driver of the tanker truck to leave the cab.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates an elevated tank for filling a tanker truck with water via a valve actuator;

FIG. 2 illustrates an exterior view of the valve actuator;

FIG. 3 illustrates the location of the valve attendant the valve actuator;

FIG. 4 is an end view illustrating the butterfly valve of the valve actuator in the closed position;

FIG. 5 is a partial view illustrating the butterfly valve in the open position;

FIG. 6 illustrates a weather-resistant box for containing batteries that provide power to the valve actuator;

FIG. 7 illustrates the manual and electrical components for operating the valve of the valve actuator;

FIG. 8 illustrates a rotatable shaft operating through a gearbox to control the position of the butterfly valve;

FIG. 9 illustrates the gearbox and shaft of the valve extending therefrom;

FIG. 10 illustrates the manual override mechanism for the butterfly valve;

FIG. 11 illustrates an alternative mounting for the solar panels to recharge the batteries;

FIG. 12 is a representative view illustrating the radio frequency receiver for controlling operation of the valve actuator; and

FIG. 12A is a representative illustration of the remote control transmitter for communicating with the receiver shown in FIG. 12.

### DESCRIPTION OF THE PREFERRED EMBODIMENT

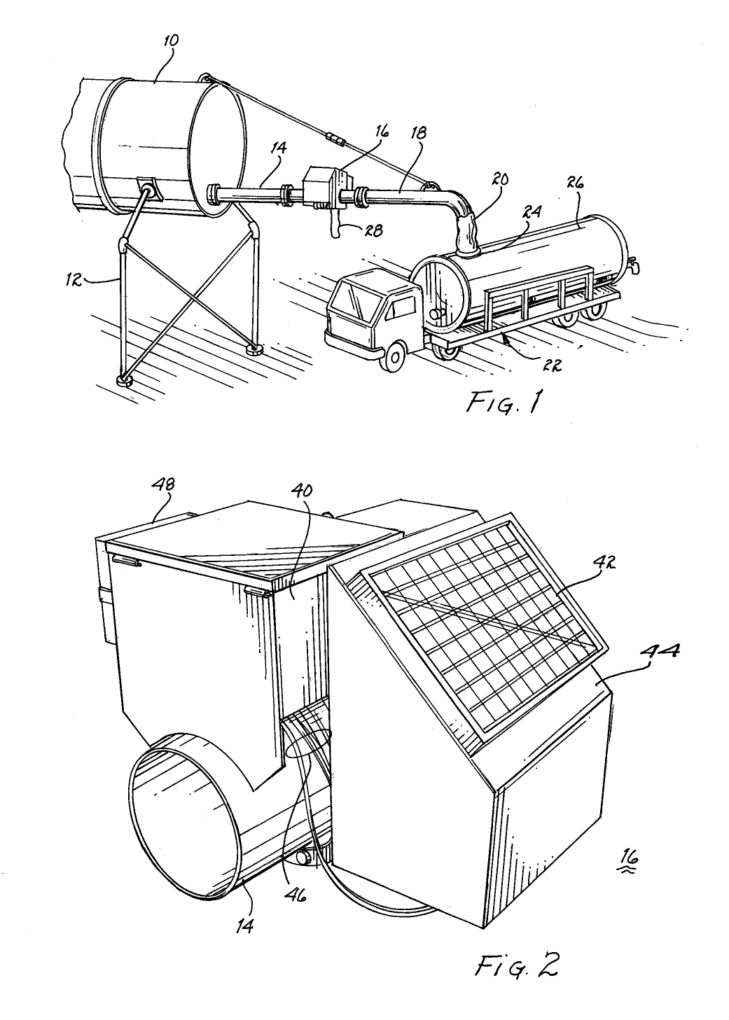

Referring to FIG. 1, there is shown a conventional elevated water tank 10 mounted upon a structure, such as stilts 12. A conduit 14 extends from the bottom of the tank for discharging water on command. A valve actuator 16 is in fluid communication with conduit 14. A further conduit 18 extends from the valve actuator and includes a downspout 20. A tanker truck 22 is driven to align a large inlet 24 of tank 26 with the downspout.

Upon energizing valve actuator 16, water will flow from tank 10 through downspout 20 into tank 26 of the tanker truck. The valve within the valve actuator may be opened and closed manually by manipulating chain 28. Alternatively, the valve may be opened by the driver of tanker truck 22 by energizing a remote control to transmit a radio frequency signal to a receiver within the valve actuator. Power to open and close the valve within the valve actuator is provided by batteries for energizing an electric motor. The batteries are continually charged by solar panels electrically connected to the batteries. These solar panels may be attached to valve actuator 16 or may be remote therefrom.

FIG. 2 illustrates the basic components of valve actuator 16. Conduit 14 conveys water from tank 10 to the valve actuator. A box 40 houses batteries for energizing an electric motor. Solar panel 42, which may be mounted upon cover 44, provides electric power to recharge the batteries. Cover 44 houses and protects the activating mechanisms for the valve. Various electrical conductors 46 extend from box 40 to provide electrical power to various components within cover 44. A panel 48 may include a radio receiver for receiving radio frequency signals transmitted by the driver operated remote control.

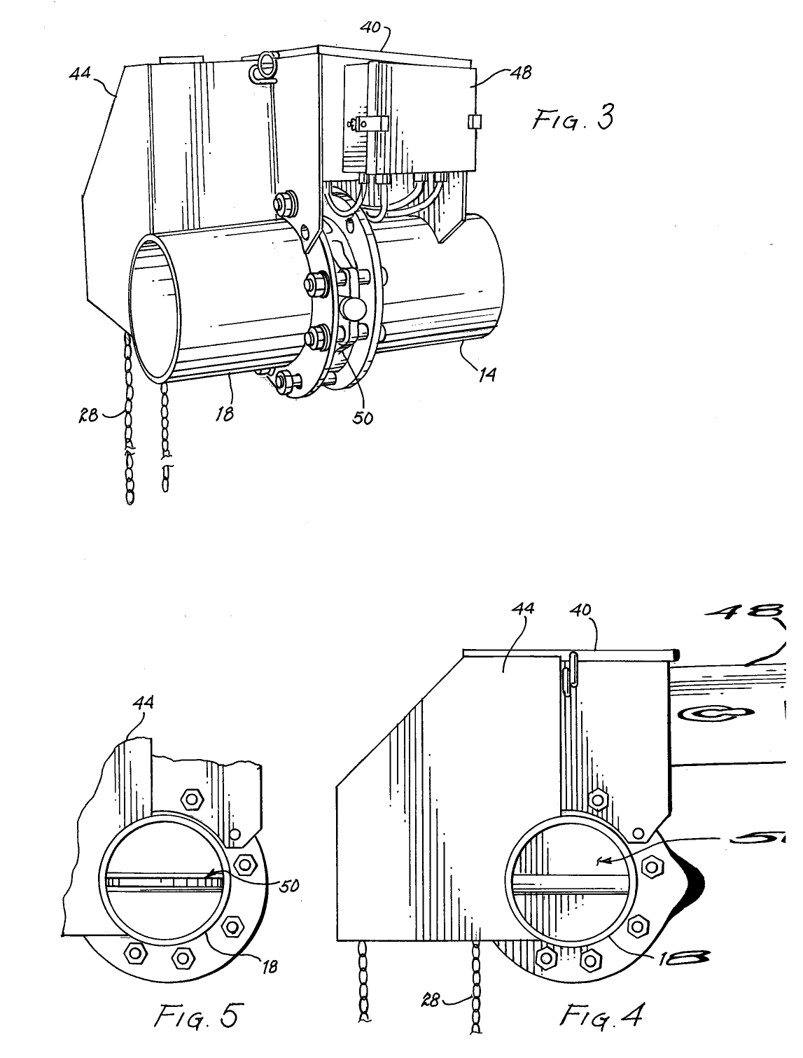

Further details attendant the valve will be described with joint reference to FIGS. 3, 4 and 5. A valve 50, such as a butterfly valve, is mounted intermediate conduits 14 and 18. As shown in FIG. 4, valve 50, depicted as a butterfly value, is closed to prevent water flow into conduit 18. FIG. 5 illustrates valve 50 in the open position to permit water to flow through the butterfly valve and into downspout 20 (see FIG. 1).

FIG. 6 illustrates box 40 containing a pair of batteries 56 and 58. To protect these batteries, a lid 60 is hingedly attached to box 40 to cover and seal the batteries against the effects of inclement weather.

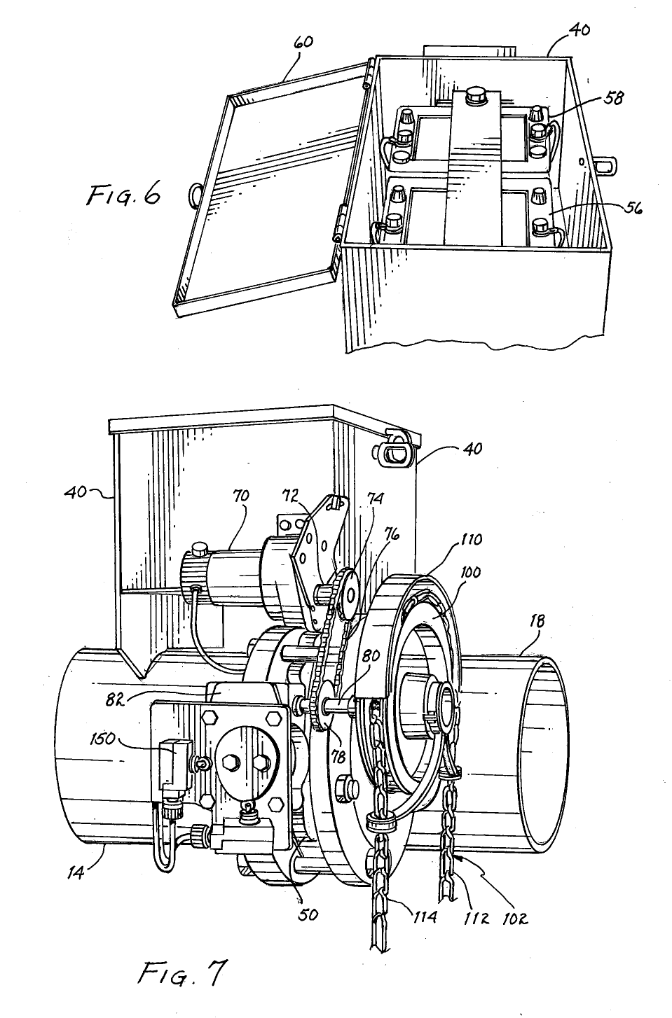

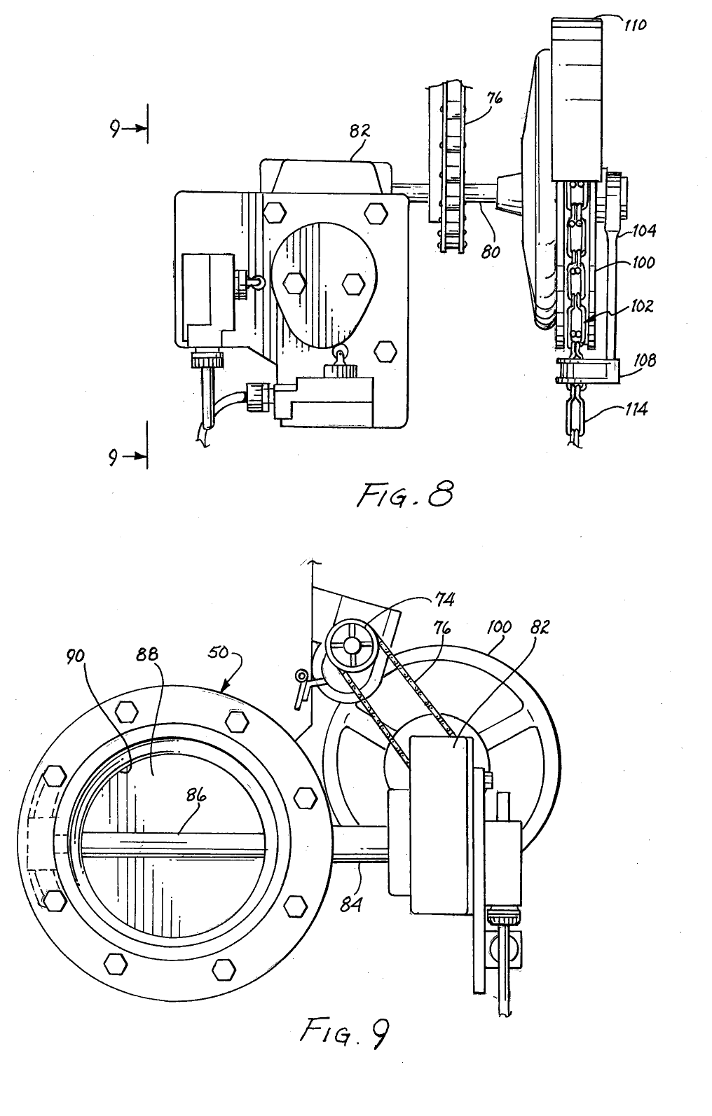

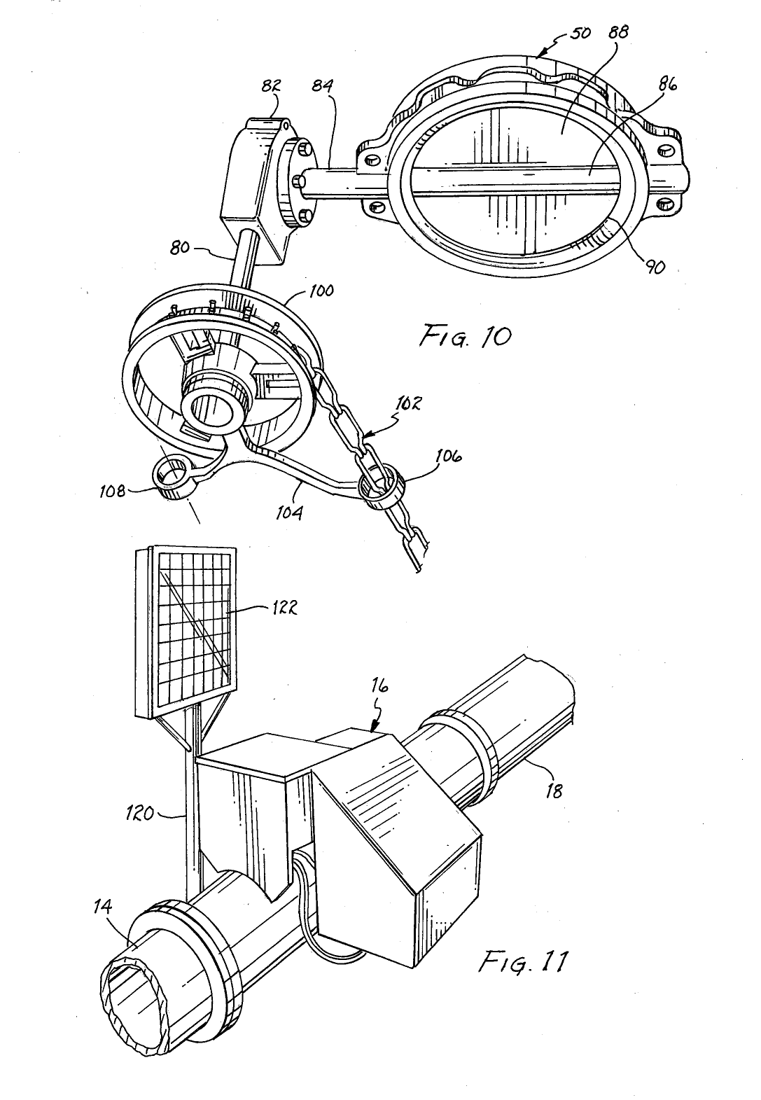

Referring jointly to FIGS. 7, 8 and 9, details attendant actuation of valve 50 will be described. As may be noted, cover 44 has been removed to illustrate the underlying mechanisms. Upon operating the remote control, electric motor 70 will be energized. Upon energization, shaft 72 will rotate and cause rotation of sprocket 74. Chain 76 extends about sprocket 74 and sprocket 78 mounted on shaft 80. Thus, rotation of shaft 72 will result in rotation of shaft 80. Shaft 80 is connected to a gearbox 82. A further shaft 84 extends from gearbox 82 into valve 50. Shaft 84 is operatively connected to a rod 86 extending across the mid part of flapper 88 of the butterfly valve. Moreover, the rod is suitably journaled within valve 50 to permit rotational movement to the extent of 90 degrees. Thereby, the flapper either extends across cylindrical housing 90 to impede fluid flow therethrough or in alignment with the longitudinal axis of housing 90 to permit fluid flow therepast.

In the event of electrical malfunction or intentional manual operation of valve 50, the attendant structure will be described primarily with reference to FIGS. 7, 8, 9 and 10. A pulley 100 is attached to shaft 80. Upon rotation of pulley 100, commensurate rotation of the shaft 80 will occur and shaft 84 will rotate as a function of gearbox 82. As is evident from FIG. 7, the shaft of electric motor 70 will similarly rotate as a result of the interconnection by chain 76. Alternatively, there may be a one way clutch to prevent rotation of the electric motor. A chain 102 is draped around the upper end of pulley 100 and depends therefrom. Preferably, the pulley includes cogs interacting with the links of chain 102 to prevent slippage between the chain and the pulley. An invented Y shaped guide 104 is rotatably attached to shaft 80 to provide rotational freedom about the axis of shaft 80 in response to forces exerted by chain 102. The guide includes a ring 106 for guiding the chain onto and away from one side of pulley 100. A further ring 108 guides the chain onto and away from the other side of pulley 100. A shroud 110 (see FIG. 7) may be incorporated to prevent the chain from becoming dislodged from about the upper side of pulley 100.

In operation, upon manually pulling down on leg 112 (see FIG. 7) of chain 102, shaft 80 will rotate clockwise and cause rotation of rod 86 and commensurate movement of flapper 88. Upon manually pulling down on leg 114 if chain 102, rod 86 and flapper 88 will be caused to move in the opposite direction. Thereby, valve 50 can be opened and closed by manipulation of chain 102.

In FIG. 2, solar cells 42 are illustrated as mounted upon cover 44. This mounting may not be optimum to expose the solar cells to sunshine for as many hours as possible. To optimize the functionality of the solar cells, they may be mounted upon a post at or remote from valve actuator 16. As shown in FIG. 11, a post 120 attached to or in proximity of valve actuator 16 may be used to support solar cells 122. It is to be understood that post 120 may be ground based or even located on tank 10 or its supporting structure if such location is optimum for exposure to sunshine.

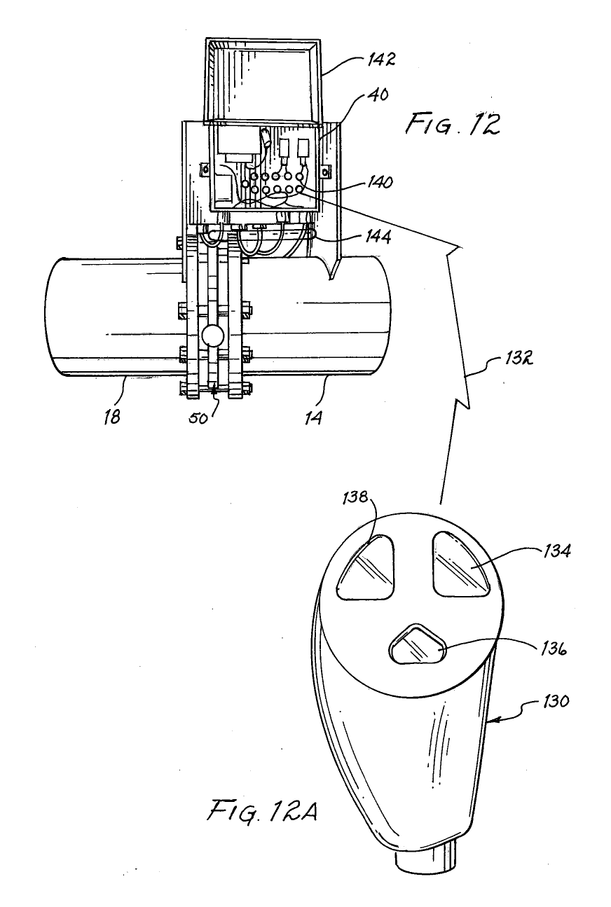

Referring jointly to FIGS. 12 and 12A, there is shown a remote control 130 for generating, on command, and transmitting a radio signal, identified by numeral 132. One or more buttons 134, 136 and 138 may be used to provide the requisite signals. A radio receiver 140 may be mounted within box 48, shown with lid 142 open. The receiver generates signals to start and stop operation of electric motor 70 (see FIG. 7) and thereby opens and closes valve 50. A plurality of electrical conductors 144 for conveying electrical signals to electric motor 70, as well as receiving electrical power from batteries 56 and 58 are shown.

It is to be understood that various limit switches and other automatic or manually settable controls may be incorporated to meet the various safety requirements and to prevent hazardous operation. Additionally, override elements may be incorporated to prevent water flow in the event of a malfunction of a component. For example, as shown in FIG. 7, an on-off switch may be used to control and thereby regulate operation of the valve actuator.

I claim:

1. Apparatus for filling the tank of a tanker truck with water from an elevated water storage tank, said apparatus comprising in combination:
a) a first conduit extending from the storage tank;
b) a second conduit for conveying water to the water truck;
c) a valve actuator disposed intermediate said first and second conduits;
d) a butterfly valve disposed in said valve actuator;
e) a gearbox and a shaft extending from said gearbox for opening and closing said butterfly valve;
f) an electric motor coupled with said gearbox for selectively rotating said shaft; and
g) a radio frequency transmitter and receiver for operating said electric motor on command.

2. The apparatus as set forth in claim 1, including a pulley coupled with said shaft and a chain depending from said pulley for manually opening and closing said butterfly valve.

3. The apparatus as set forth in claim 2, including a further shaft extending from said gearbox and coupled with said pulley.

4. The apparatus as set forth in claim 3, including a sprocket coupled with said electric motor, a further sprocket coupled with said further shaft and a chain interconnecting said sprocket and said further sprocket.

5. The apparatus as set forth in claim 1, including at least one battery for providing electrical power to said electric motor.

6. The apparatus as set forth in claim 6, including a solar panel for recharging said at least one battery.

7. The apparatus as set forth in claim 2, including a guide coupled with said further shaft for guiding said chain depending from opposed sides of said pulley.

8. The apparatus as set forth in claim 7, including a shroud disposed about the upper part of said pulley for retaining the adjacent segment of said chain within said pulley.

9. The apparatus as set forth in claim 5, including a pulley coupled with said gearbox and a chain depending from said gearbox for manually opening and closing said butterfly valve.

10. The apparatus as set forth in claim 9, including a further shaft extending from said gearbox and coupled with said pulley.

11. The apparatus as set forth in claim 10, including a sprocket coupled with said electric motor, a further sprocket coupled with said further shaft and a chain interconnecting said sprocket and said further sprocket.

12. The apparatus as set forth in claim 1, wherein the tanker truck includes an inlet for water flow and including a shroud extending from said second conduit for conveying water through said inlet into the tanker truck.

13. Apparatus for selectively discharging water into the tank of a tanker truck, said apparatus comprising in combination:
a) an elevated water storage tank;
b) a first conduit extending from said storage tank to an end;
c) a valve actuator attached to the end of said first conduit in fluid communication with an inlet of said valve actuator;
d) a second conduit extending from an outlet of said valve actuator for discharging water into the tank of the tanker truck;
e) a butterfly valve disposed within said valve actuator for controlling the flow of water from said first conduit into said second conduit;
f) a gearbox having a rotatable output shaft for effecting rotation of said butterfly valve;
g) a rotatable input shaft extending from said gearbox for effecting rotation of said output shaft; and
h) means for rotating said input shaft to open and close said butterfly valve.

14. The apparatus as set forth in claim 13 wherein said rotating means comprises an electric motor for selectively rotating said input shaft and a source of electric power for energizing said electric motor.

15. The apparatus as set forth in claim 14, including a remote control comprising a transmitter and a receiver for using a radio frequency signal to control operation of said electric motor.

16. The apparatus as set forth in claim 13 wherein said rotating means comprises a pulley coupled with said input shaft and a chain depending from said pulley for manually rotating said input shaft.

17. The apparatus as set forth in claim 16 wherein said rotating means includes an electric motor for selectively rotating said input shaft and a source of electric power for energizing said electric motor.

18. The apparatus as set forth in claim 17, including a remote control comprising a transmitter and a receiver for using a radio frequency signal to control operation of said electric motor.

19. A method for conveying water from an elevated tank to the tank of a tanker truck, said method comprising the steps of:
a) causing a flow of water through a first conduit from the elevated tank to a valve actuator;
b) selectively opening and closing the valve actuator to accommodate a flow of water into a second conduit coupled with the tank of the tanker truck;
c) energizing an electric motor to selectively open and close a butterfly valve disposed in the valve actuator to control the flow of water into the second conduit; and
d) in the alternative, the step of operating the butterfly valve manually through a chain and pulley device or the step of energizing the electric motor.

20. The method as set forth in claim 19, including the step of transmitting a radio frequency signal from a remote control to a receiver associated with the valve actuator to selectively carry out said step of energizing.
